(19) United States
(12) Patent Application Publication
(10) Pub. No.: US 2008/0104682 A1
(43) Pub. Date: May 1, 2008

(54) Secure Content Routing

(75) Inventors: Daniel F. Emerson, Redmond, WA (US); Craig I. McLuckie, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/555,637

(22) Filed: Nov. 1, 2006

(51) Int. Cl. H04L 9/32

(52) U.S. Cl. 726/5

(57) ABSTRACT

Various embodiments employ methods and techniques to manage content flow in an efficient and secure manner. The methods and techniques, in at least some embodiments, enable a content consumer to pull content from a content creator and further control access to content using various verification methods and protocols. Other embodiments allow for increased security in content push scenarios. Further to some embodiments, methods and techniques can be used to control access to content via the acquisition and management of user and/or client credentials.

### BACKGROUND

Managing content workflow in an efficient and secure manner is an important property of any content management solution. Most current content management methods utilize an unsecured “push” model, whereby an input device pushes data to a host device and/or a host device pushes data to an output device. In the context of printing and scanning devices, this means that a content creator—for example, a desktop computer in print scenarios and a scanner in scanning scenarios—manages content workflow and pushes content out to a content consumer, such as a printer in printing scenarios and a desktop computer in scanning scenarios.

Yet, a need exists for improved content management systems that provide for consumer flexibility, ensure access to content consumers, and maintain the privacy of the content creator and the security of the content itself.

### SUMMARY

Various embodiments employ methods and techniques to manage content flow in an efficient and secure manner. The methods and techniques, in at least some embodiments, enable a content consumer to pull content from a content creator and further control access to content using various authentication and encryption methods and protocols. Other embodiments allow for increased security in content push scenarios. Further to some embodiments, methods and techniques utilize acquisition and management of client and/or user credentials to control access to content, route content and/or process content

### BRIEF DESCRIPTION OF THE DRAWINGS

FIG. 1 illustrates an exemplary secure content container in accordance with one embodiment.

FIG. 1a illustrates an exemplary system that utilizes pool-based pull printing in accordance with one embodiment.

FIG. 2 is a flow diagram in accordance with one embodiment of a pool-based pull printing method.

FIG. 3 illustrates an exemplary system that utilizes pull printing in accordance with one embodiment.

FIG. 4 is a flow diagram in accordance with one embodiment Of a pull printing method.

FIG. 5 illustrates an exemplary system that utilizes push scanning in accordance with one embodiment.

FIG. 6 is a flow diagram in accordance with one embodiment of a push scanning method.

FIG. 7 illustrates an exemplary system that utilizes pool-based push scanning in accordance with one embodiment.

FIG. 8 is a flow diagram in accordance with one embodiment of a pool-based push scanning method.

FIG. 9 illustrates an exemplary system that utilizes push printing in accordance with one embodiment.

FIG. 10 is a flow diagram in accordance with one embodiment of a push printing method.

FIG. 11 illustrates an exemplary system that utilizes pull scanning in accordance with one embodiment.

FIG. 12 is a flow diagram in accordance with one embodiment of a pull scanning method.

### DETAILED DESCRIPTION

Overview

Various embodiments employ methods and techniques to manage content flow in an efficient and secure manner. Examples of content can include text, graphics and the like. These examples are not intended to be limiting, and other suitable forms of content may be utilized. The methods and techniques, in at least some embodiments, enable a content consumer to pull content from a content creator and further control access to content using various authentication methods and protocols. Other embodiments allow for increased security in content push scenarios. Further to some embodiments, methods and techniques can be used to control access to content via acquisition and management of client and/or user credentials. While the exemplary embodiments discussed herein are explained with reference to particular devices, this is not intended to be limiting, and other devices may be utilized such as printers, scanners, facsimile machines, multifunction devices and the like. Further to some embodiments, the computers and computing devices discussed herein may include one or more processors, one or more computer-readable media and one or more applications.

The discussion below proceeds as follows: First, a secure content container is discussed. The exemplary secure content container can be used in the printing/scanning scenarios that are subsequently described. The next section discusses embodiments that utilize pool-based pull printing. Following this, embodiments that utilize pull printing are discussed. Still further, embodiments are discussed that implement push scanning techniques. The next section then discusses the notion of pool-based push scanning. Following this, embodiments that utilize push printing are discussed. Finally, embodiments that describe pull scanning are discussed.

Exemplary Secure Content Container

A secure content container, as utilized in this document, is a logical entity that comprises one or more content streams in a single electronic representation and enables content to be routed in a secure and efficient way. The secure aspect can be particularly useful in network environments where it may be desirable to prevent unauthorized access to data or content. The exemplary secure content container (or ones similar to or sharing characteristics with it) can be used in the various printing and scanning scenarios that are subsequently described. In practice, the secure content container resides in electronic form on some type of computer-readable medium.

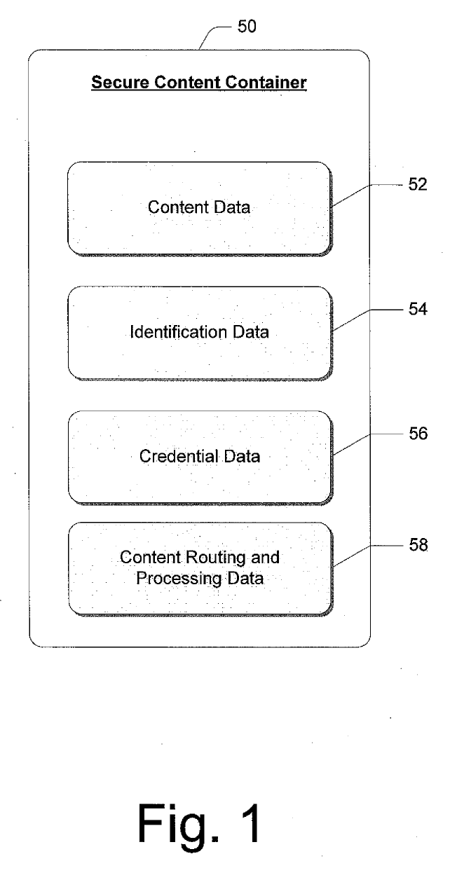

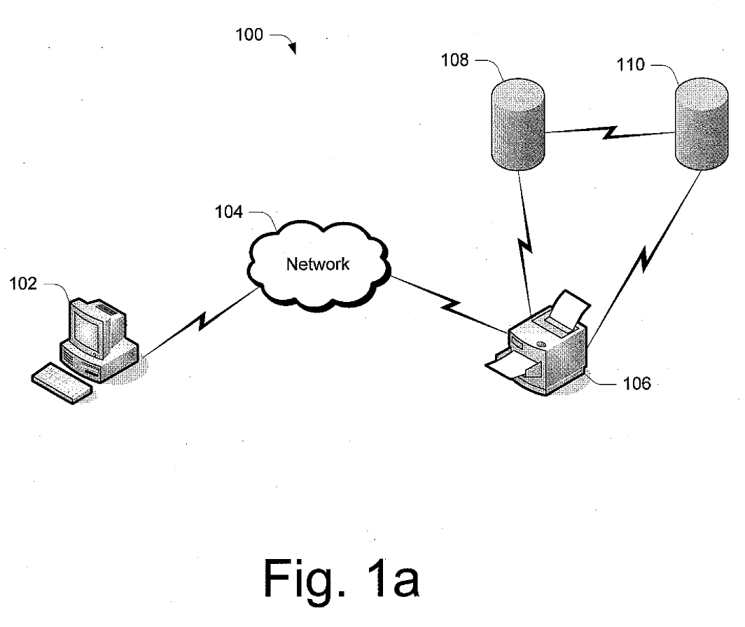

As but one example of a secure content container, consider FIG. 1. There, a secure content container 50 may contain various types of data including content data 52, identification data 54, credential data 56, and content routing and processing data 58. In some embodiments, secure content container 50 is assembled or created, and then the various types of data are added to the secure content container.

Content data 52 includes the actual content that is to be consumed or otherwise used by some type of device. For example, content data may reside in the form of a document and the like.

Identification data 54 can include user identification data. In some embodiments, user identification data can be used to access credentials. Credential data 56 can include user and/or client credential data. The term user can refer to an individual user or a specific group of users. The term client can refer to a specific device or group of devices (e.g. a group of computers). And, although in the examples below user credentials are described, it is to be appreciated and understood that client credentials can be used in at least some of the embodiments. Further, content processing data can include printer settings, scanner settings and the like. As will become apparent from the discussion below, however, other embodiments of a secure content container may contain other types of data or content.

Content processing data 58 may further include information that may be used by a printer to initiate an auxiliary work flow associated with the content. Examples of auxiliary work flows include content caching procedures, content compliance procedures, content filtering procedures and the like.

In some embodiments, the secure content container includes content data and an indication of a particular user or user group. Examples of a user indication include a user identifier or an indication of user credentials. Further to the secure aspect of the secure content container, the content data therein may be encrypted using any suitable encryption method. Examples of suitable encryption methods include RSA encryption, Diffie-Hellman encryption, or any other suitable encryption protocol. In some embodiments, this involves encrypting the content data using user credentials associated with a user. Further to these embodiments, user credentials can be used to establish user identity. This identity can then be used to obtain information (e.g. a cryptographic key) that can then be used to encrypt content data using any suitable encryption method. A security token may then be embedded in the content data itself and/or in the secure content container. According to some embodiments, the security token may be a Kerberos ticket or an X509 certificate. The security token links the information used to encrypt the content data with the identity of the user that created the content, allowing the information needed to decrypt the content data to be retrieved, along with any credentials needed to further process the content data.

As discussed herein, user credentials allow for a complex and secured representation of a user that may be used to authenticate aspects of a user's identity. In some embodiments, credentials comprise an object or objects that are verified when they are presented to a verification entity as part of an authentication transaction. As is commonly known in the art, credentials may be used for both identification and authorization.

Suitable authentication methods include, but are not limited to, the Kerberos authentication protocol, the X.509 standard and the like. Thus, according to some embodiments, a user's credentials can be used to identify a user, authenticate a user, and encrypt and decrypt content associated with a user. However, these terms are not intended to be mutually exclusive, and the acts of identification, authentication, encryption and decryption may overlap in certain scenarios. Accordingly, in embodiments where content data is encrypted using user credentials, the indication of user identification in the secure content container includes an indication of user credentials. This indication may be utilized to subsequently identify and/or retrieve the actual user credentials in order to decrypt the encrypted content data.

It is to be noted that any encryption scheme utilized to encrypt content is not necessarily tied to the user authentication or verification. As such, any suitable encryption, authentication and verification scheme, either alone or in combination with other schemes, may be utilized by the embodiments discussed herein.

Having described an exemplary secure content container, consider now various printing/scanning embodiments that can utilize a secure content container.

Pool-Based Pull Printing

As used herein, the term “pool” refers to the idea that one or more instances of content may coexist in a particular environment) and that the environment may be accessible to multiple entities. One example of such an environment is a network. Multiple network resources may connect and interact with a single network. Thus, the network may serve as a pool that can receive content from one or more network resources and forward content to one or more network resources. In some embodiments, a pool comprises a set of devices (e.g. scan and/or print devices) and each of the devices may have different features.

A network or system that can utilize pooled pull printing is illustrated generally in FIG. 1a at 100. The term “pull” refers generally to systems and methods that retrieve content at a destination from some type of content store. System 100 includes a computing device 102 that may be utilized to create or manipulate content. A desktop computer is shown here for purposes of illustration only, and other suitable devices may be employed herein. Examples of other suitable devices include portable digital assistants (PDAs), laptop computers, cellular phones and the like.

System 100 further includes network 104. An example of network 104 is the Internet, although it is to be appreciated that other suitable networks may be employed without departing from the spirit and scope of the claimed subject matter such as LANs, WANs and the like. Further to the pool-based aspect of the discussed embodiments, network 104 may connect computing device 102 to a set of content consumers that may be considered members of a pool. Content may be routed to a member of the pool based on one or more routing criteria. Routing a criteria may include a simple schedule, e.g., the content is routed to the first available device. Routing criteria may be more complex, however, and may include routing content based on an indication of user credentials or output settings in a secure content container. Thus, any content consumer that is a member of the pool may potentially pull content from computing device 102.

System 100 also includes a content consumer 106. Although content consumer 106 is illustrated here as a printer, this is not intended to be limiting, and a content consumer may comprise any device suitable for receiving and processing content, such as a facsimile machine, a multipurpose device and the like. Optionally to system 100 is a credentials cache, which is shown here at 108. As will be explained below, credentials may be directly provided to a content consumer by a user, or credentials may be retrieved from a credentials cache based on an identifier or credentials indicator supplied by a user to the content consumer. Also shown here is optional directory service 110. Directory service 110, when implemented, may interact with credentials cache 108 and/or content consumer 106 to manage user credentials and network resources.

In operation, system 100 enables content consumer 106 to pull content from device 102 via network 104. According to one embodiment, device 102 creates or manipulates content in some fashion, encrypts the content using user credentials, and then places the encrypted content in a secure content container. As discussed above, the secure content container further includes some indication of the identity of the user associated with device 102. In some embodiments, this may include a security token that is used to establish the identity of the user. In some embodiments, the secure content container includes encrypted content that is to be printed by a print resource that may or may not be identified at the point at which the secure content container is assembled. As discussed above, the secure content container may further include print settings associated with the content. Further to the operation of system 100, the secure content container is then sent from device 102 to network 104. In some embodiments, the secure content container may be cached by a resource associated with network 104 until content consumer 106 retrieves it.

Once the secure content container is sent to the network, a user may approach content consumer 106 and provide some indication of the user identity. As discussed above, the indication of user identity may include user credentials or some indication that enables content consumer 106 to retrieve user credentials based on the indication. If content consumer 106 authenticates the user identity and/or credentials, then the secure content container can be retrieved and processed by the content consumer. In some embodiments, processing the secure content container can include decrypting the encrypted content contained therein using the user credentials. Thus, as is apparent from this discussion, the content contained in this embodiment of the secure content container is undecryptable without access to the user-associated credentials. This allows for end to end content security, particularly in the embodiments where the secure content container may reside for any amount of time at a publicly accessible location, such as a network.

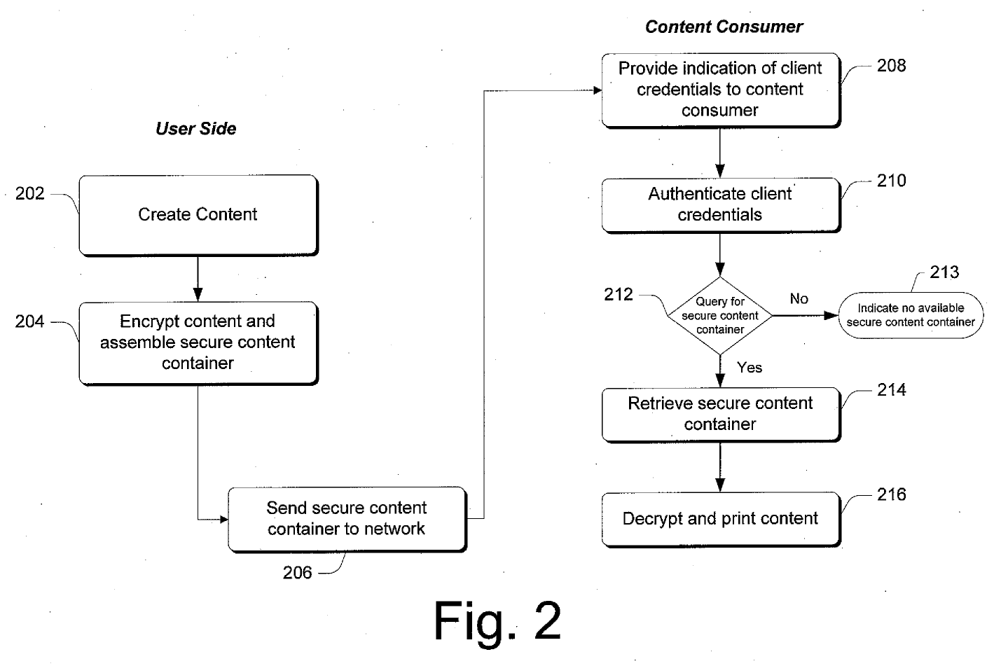

FIG. 2 illustrates a flow diagram in accordance with one embodiment of a pooled pull printing method. The method can be implemented in connection with any suitable hardware, software, firmware or combination thereof. FIG. 1a constitutes but one example of a system that can implement the following method. The described method is divided into acts that are performed on the user side, and acts that are performed on the content consumer's side.

Act 202 creates or manipulates content. Act 202 may occur on a client device, e.g. a desktop computer, or any other device capable of creating and/or manipulating content. In some embodiments, act 202 includes assembling content to be printed by a printer. Act 204 assembles a secure content container, encrypts the content using the credentials and places the encrypted content into the secure content container. In some embodiments, the credentials used to encrypt the content are associated with a specific user or user group. As mentioned above, the secure content container may also include an indication of the user identity. In some embodiments, this indication comprises a header that either identifies the user or provides an indication of the user credentials. Act 206 sends the secure content container to a network, where the secure content container may be cached.

Act 208 provides an indication of user credentials to a content consumer. As discussed above, the content consumer may be part of a pool which includes one or more content consumers. In one embodiment, the content consumer is a network printer. Any suitable method can be used to provide an indication of user credentials. For example, a person may physically walk up to a content consumer and type in, via an input mechanism, an indication of their credentials. Alternately or additionally, a person might provide the indication via a smart card that is inserted into the content consumer. Other suitable means of providing an indication of credentials can include radio frequency identification (REID), biometric identification and the like.

Act 210 authenticates the user's credentials. Act 210 may be performed in several different ways. User credentials enable the content consumer to authenticate the user identity and retrieve credentials associated with the user. As part of act 210, user credentials may be retrieved from a credentials cache that is either located on the content consumer itself or is external to the content consumer.

Act 212 queries the network for any secure content containers associated with the identified and authenticated user. In some embodiments, act 212 includes querying the network for any pending print jobs associated with the identified user. If no user-associated secure content containers are identified, act 213 indicates that there are no available secure content containers. If one or more secure content containers associated with the user are identified, act 214 retrieves the secure content container(s). Act 216 decrypts the encrypted content and makes it available to the user. As discussed above, in some embodiments the encrypted content is decrypted using the user credentials that were initially used to encrypt the content. In some embodiments, act 216 fiber includes printing the decrypted content.

As discussed above, pool-based pull printing methods utilize a user's identity to locate content from a local or distributed content store. Thus, in some embodiments, content is routed and accessed (both from a content store and from the secure content container itself) based on an identity that a user establishes at a content consumer and, further to some embodiments, using the supplied credentials.

Pull Printing

FIG. 3 illustrates, generally at 300, a network or system that can implement pull printing in accordance with one embodiment. In the illustrated embodiment, system 300 includes printer 302, content source 304a and content source 304b. Two content sources are presented here for purposes of illustration only, and other systems may include any suitable number of content sources.

In operation, a user approaches printer 302 and requests a particular print job. In one embodiment, the request is made by providing an indication of user credentials to the printer. The authentication, verification and credential management methods discussed above, as well as any other suitable method(s), can be utilized herein. Based at least in part on the indication of user credentials, printer 302 may identify a previously-specified print job request. Alternatively, the user enters a print job request into the printer using a suitable input means. Suitable input means include an alpha numeric keyboard, a keypad, a touch screen and the like. The printer authenticates the user's credentials and retrieves the requested print job. The printer then prints the print job or, in some embodiments, caches the print job for later retrieval.

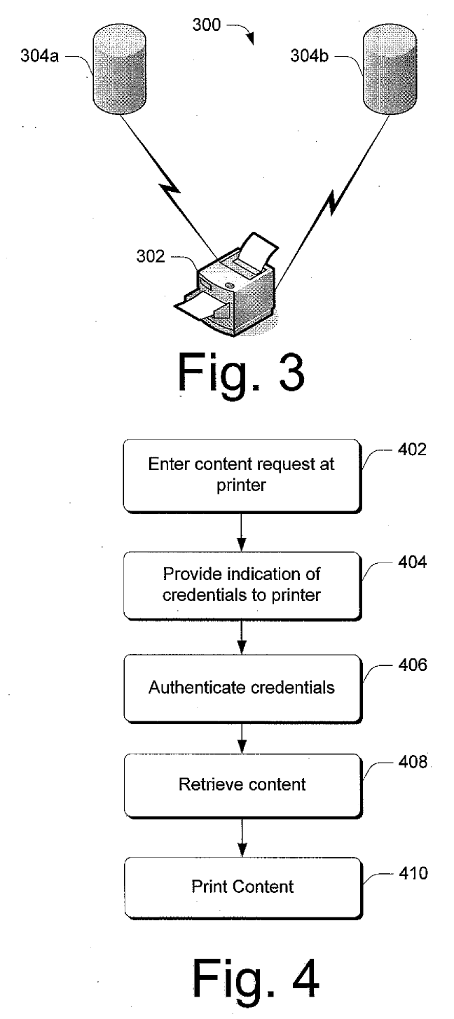

FIG. 4 illustrates a flow diagram in accordance with one embodiment of a pull printing method. The method can be implemented in connection with any suitable hardware, software, firmware or combination thereof. FIG. 3 constitutes but one example of a system that can implement the following method.

Act 402 enters a content request into a printer. As discussed above, the content request may be mapped based on a user's credentials or the request may be entered using a suitable input means. Act 404 provides an indication of user credentials to the printer. Act 406 authenticates the user's credentials. Act 408 retrieves the requested content based at least in part on the authenticated credentials. As but one example, act 408 may involve retrieving content from a remote source. For example, the printer may retrieve a newspaper from a content source associated with the newspaper. Thus, according to one embodiment, a user requests a newspaper from the printer and the printer retrieves the newspaper. Act 410 prints the requested content. In some embodiments, the requested content may not be immediately printed but is cached so that the content may be processed at a subsequent time. Further to some embodiments, the user credentials may be used for content billing purposes.

Push Scanning

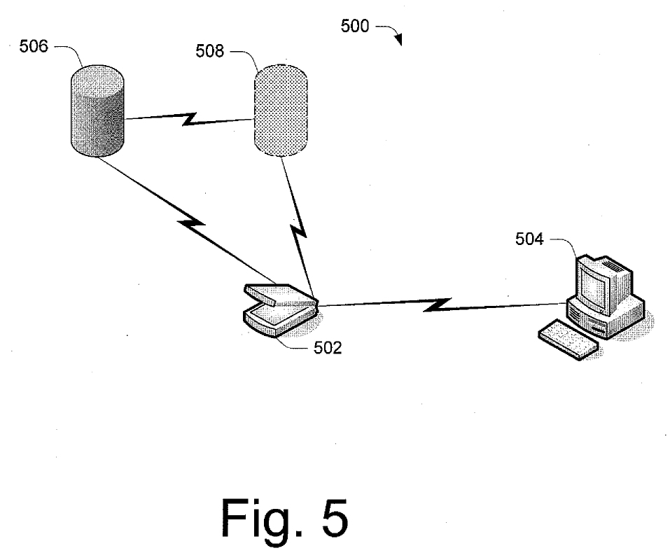

FIG. 5 illustrates, in accordance with one embodiment, a network or system that can implement push scanning generally at 500. The term “push” refers generally to systems and methods that send content to one or more destinations. System 500 includes a scanner 502, a client computer 504, a content repository 506, and, optionally, a directory service 508.

In operation, a user approaches scanner 502 and provides content that is to be scanned. Along with the content, the user provides an indication of the user's credentials. As explained above, this indication can include the credentials themselves or some indication that allows the credentials to be retrieved. The authentication, verification and credential management methods discussed above, as well as any other suitable method(s), can be utilized herein.

In some embodiments, the user can then specify a desired destination for the scanned content. In other embodiments, however, the user's credentials can be mapped to a policy that specifies how the content is to be processed and/or a destination for the scanned content. According to some embodiments, the content destination may be client computer 504, content repository 506, or any other suitable entity capable of receiving content. Scanner 502 can then scan the content, encrypt the content using the user's credentials, assemble the content into a secure content container and process and/or send the content according to user's specifications or the user-associated policy. The user credentials may also be used to write the encrypted content to a document store. As but one example, user credentials may allow scanned encrypted content to be authenticated and written to a file share location that is controlled by an access control list. Further to some embodiments, the specifications provided by the user may be combined with a user-associated policy in processing and sending the scanned content. Optional directory service 508 may be employed to assist in managing user credentials, user-associated policies and system resources.

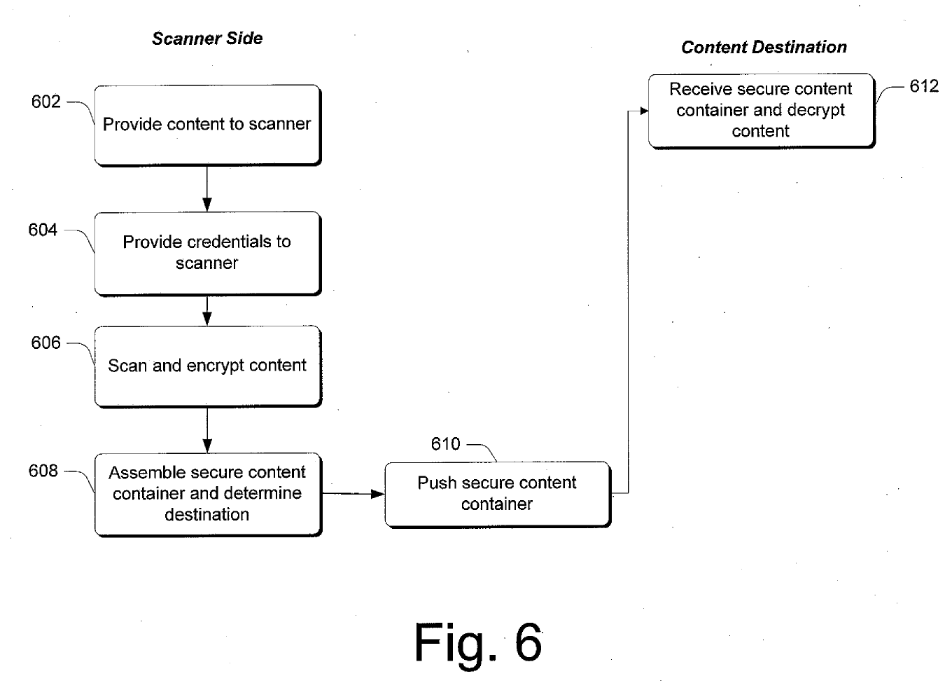

FIG. 6 illustrates a flow diagram in accordance with one embodiment of a push scanning method. FIG. 5 constitutes but one example of a system that can implement the following method. The method can be implemented in connection with any suitable hardware, software, firmware or combination thereof.

Act 602 provides content to a scanner and act 604 provides user credentials to the content scanner. These acts can be performed by an individual or user using the methods described above for managing and authenticating user credentials, or any other suitable method(s). Act 606 scans the content and encrypts the content using the credentials Act 608 assembles the encrypted content into a secure content container and determines a destination for the secure content container. Suitable embodiments of a secure content container are discussed above and may be employed herein. It is also to be understood that the disclosed embodiments are not limited to a single secure content container destination, and the term destination, as used herein, may refer to multiple locations and/or clients. As discussed above, the destination may be specified by the user at the time that the content is provided to the scanner, or may be determined according to a pre-specified policy, or a combination of both. Act 610 pushes the secure content container out to the determined destination. Act 612 receives the secure content container at the determined destination and decrypts the encrypted content therein using the credentials.

Pool-Based Push Scanning

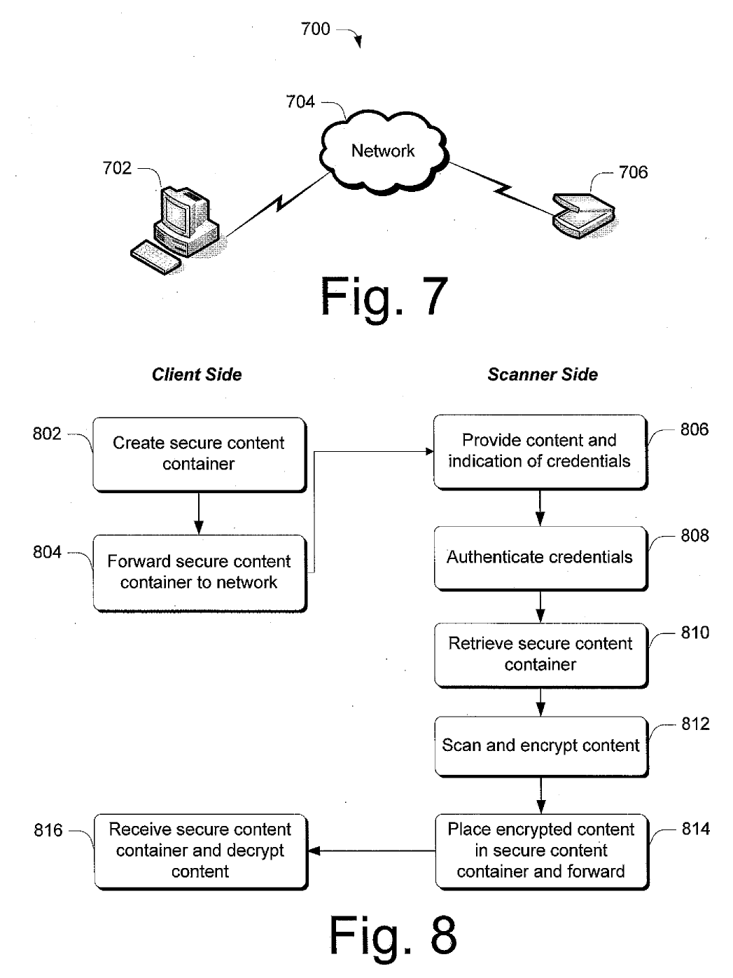

FIG. 7 illustrates, generally at 700, a network or system that can implement pool scanning in accordance with one embodiment.

In the illustrated embodiment, system 700 includes client computer 702, network 704, and scanner 706. Although a desktop computer is illustrated here at 702, any suitable device may be utilized. Examples of other suitable devices include laptop computers, PDAs, cellular phones and the like.

In operation, a user creates a secure content container on client computer 702, but without actually placing content into the container. The secure content container may contain information such as an indication of user credentials, any scanner settings associated with the scan job and secure content container routing instructions. The secure content container is then sent to network 704. Any suitable network may be utilized and, in at least one embodiment, network 704 comprises the Internet. A user then approaches scanner 706 and provides an indication of user credentials along with content to be scanned. The authentication, verification and credential management methods discussed above, as well as any other suitable method(s), can be utilized herein. Scanner 706 queries network 704 for secure content container(s) associated with the user credentials. Scanner 706 retrieves the secure content container, scans the content, and encrypts the content using the user credentials. The encrypted content is then placed into the secure content container and routed to one or more destinations. The secure content container is accessed at the destination(s) and decrypted with the user credentials.

FIG. 8 illustrates a flow diagram in accordance with one embodiment of a pool-based push scanning method. FIG. 7 constitutes but one example of a system that can implement the following method. The method can be implemented in connection with any suitable hardware, software, firmware or combination thereof.

Act 802 creates a secure content container. As discussed above, the secure content container need not contain any content, but may contain other information such as an indication of user credentials, any scanner settings associated with the scan job and secure content container routing instructions. Act 804 sends the secure content container to a network. Act 806 provides content to be scanned and an indication of user credentials to the identified scanner. This act can be performed by a user or a party authorized to act on behalf of a user. Act 808 authenticates the user credentials. Based at least in part on the authenticated credentials, act 810 retrieves the secure content container from the network. While a single secure content container is discussed with respect to this embodiment, some embodiments may utilize multiple secure content containers. Act 812 scans the content and encrypts the content using the user credentials. Act 814 places the encrypted content into the secure content container and routes the secure content container to one or more specified destinations. The secure content container destination(s) may be specified according to information contained in the secure content container and/or by some other means. Act 816 receives the secure content container at the destination(s) and decrypts the encrypted content using the user credentials.

Push Printing

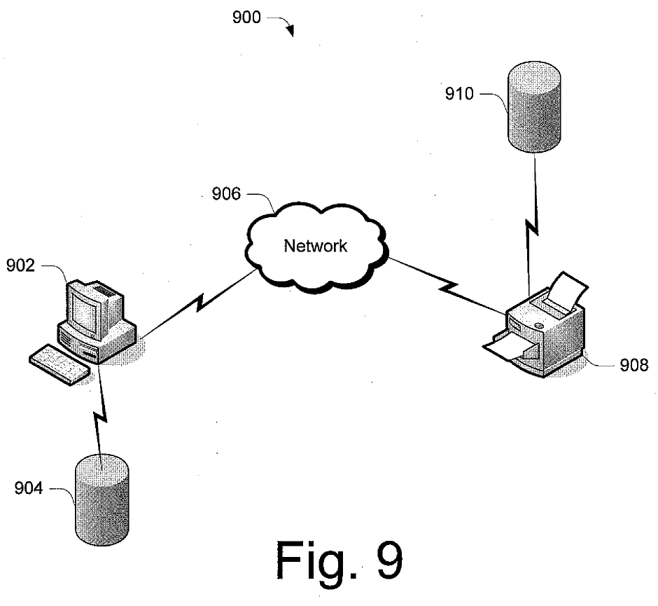

FIG. 9 illustrates, generally at 900, a network or system that can implement push printing in accordance with one embodiment.

System 900 includes a client computer 902, a content store 904, a network 906, a network printer 908, and an auxiliary content store 910. The illustration of client computer 902 is not intended to be limiting, and other devices may be employed that are suitable for creating and/or manipulating content. Examples of other suitable devices include laptop computers, portable digital assistants (PDAs), cellular phones and the like.

In operation, system 900 enables a user to create or manipulate content with client computer 902. In some embodiments, this may include obtaining content from an external content store, e.g., content store 904. Client computer 902 encrypts the content using user credentials and builds a secure content container that includes the encrypted content and other data, as discussed below. The secure content container is then sent to network 906 and forwarded to printer 908. Printer 908 may then decrypt and print the content.

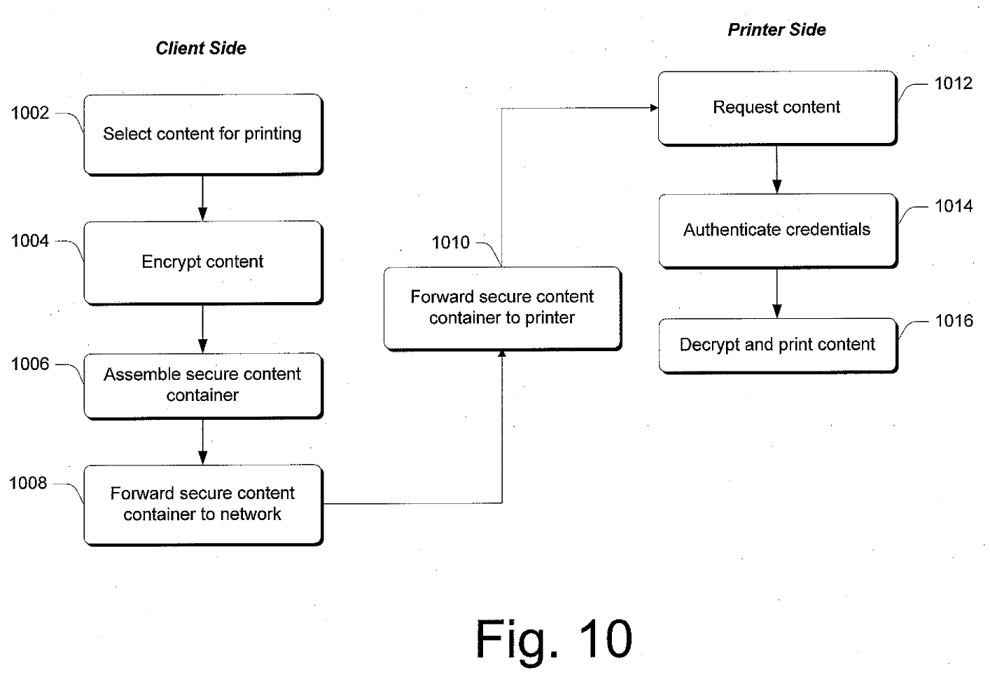

FIG. 10 is a flow diagram that describes a push printing method in accordance with one embodiment. FIG. 9 constitutes but one example of a system that can implement the following method. The method can be implemented in connection with any suitable hardware, software, firmware or combination thereof, such as the system shown and described just above.

Act 1002 selects content that is to be printed. Act 1004 encrypts the content using credentials associated with a particular user or user group. The authentication, verification and credential management methods discussed above, as well as any other suitable method(s), can be utilized herein. Act 1006 assembles a secure content container that contains the encrypted content. The secure content container may also contain other information such as an indication of the credentials that were used to encrypt the content, printer destination identification information, printer settings that are to be used to print the content, and information that may be used by a printer to initiate an auxiliary work flow associated with the content. Examples of auxiliary work flows include content caching procedures, content compliance procedures, content filtering procedures and the like. Act 1008 forwards the secure content container to a network. In some embodiments, the network may comprise the Internet.

Act 1010 forwards or “pushes” the secure content container to the destination printer. Although not expressly illustrated here, some embodiments may not utilize a network, and thus the secure content container may be sent to the printer via other protocols or connectivity methods.

Further to this embodiment, act 1012 requests content, such as a document, at the printer by providing the printer with an indication of user credentials. Previously discussed methods and techniques for credentials management and user authentication may be utilized herein. In some embodiments, act 1012 may include requesting the secure content container that contains the content. Act 1014 authenticates the user credentials. Act 1016 decrypts the content using the user credentials and prints the content. In some embodiments, the printer may initiate one or more auxiliary work flows. Examples of such work flows are given above.

Pull Scanning

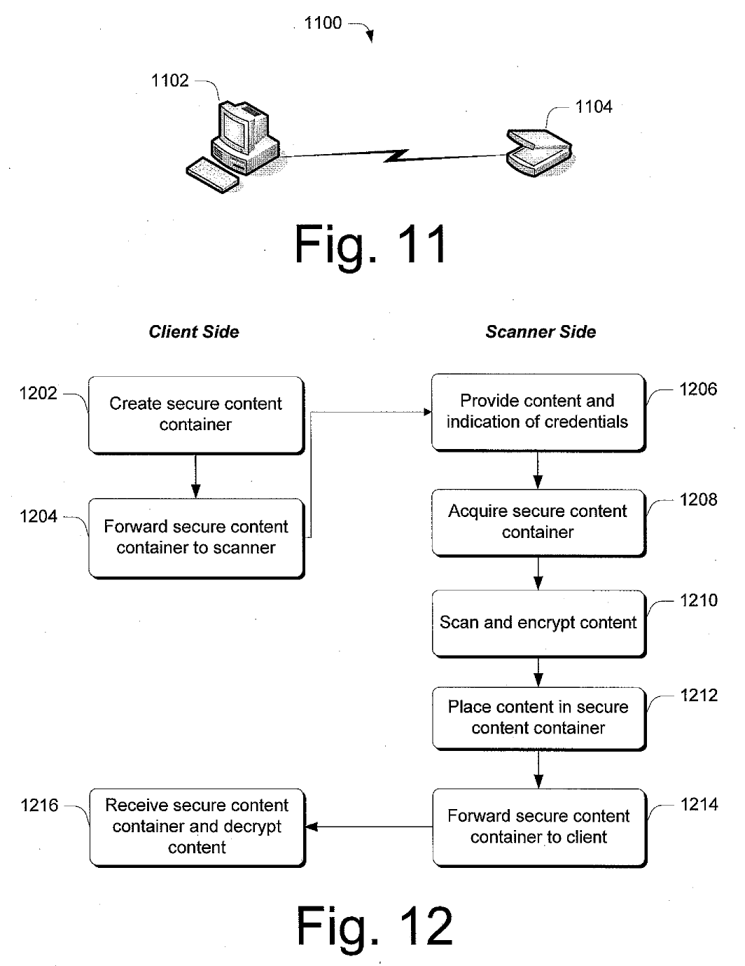

FIG. 11 illustrates, generally at 1100, a network or system that can implement pull scanning in accordance with one embodiment. System 1100 includes a client computer 1102 and a scanner 1104. Although a desktop computer is illustrated here at 1102, any suitable device may be utilized. Examples of other suitable devices include laptop computers, PDAs, cellular phones and the like.

In operation, a user initiates a scan job by creating a secure content container at client computer 1102, but without actually placing content into the container. The secure content container may contain information such as an indication of user credentials, an identification of the destination scanner and any scanner settings associated with the scan job. The secure content container is then sent to scanner 1104. A user then initiates the scan job at scanner 1104 by providing content to be scanned and an indication of the user's credentials to the scanner. The authentication, verification and credential management methods discussed above, as well as any other suitable method(s), can be utilized herein. The scanner identifies the secure content container based on the user's credentials. The content is scanned, encrypted using the user's credentials, and placed into the secure content container. The secure content container containing the encrypted content is sent back to client computer 1102. In some embodiments, the user credentials may be used to route the secure content container to a shared resource associated with client computer 1102. Client computer 1102 decrypts the encrypted content using the user credentials.

FIG. 12 illustrates a flow diagram in accordance with one embodiment of a pull scanning method. FIG. 11 constitutes but one example of a system that can implement the following method. The method can be implemented in connection with any suitable hardware, software, firmware or combination thereof.

Act 1202 creates a secure content container. As discussed above, the secure content container need not contain any content, but may contain other information such as an indication of user credentials, an identification of the destination scanner and any scanner settings associated with a scan job. Act 1204 forwards the secure content container to a scanner. In some embodiments, act 1204 may involve forwarding the secure content container to an intermediate content store that the scanner may then pull the secure content container from.

Act 1206 provides content and an indication of user credentials to the scanner. Act 1208 acquires the secure content container based at least in part on the indication of user credentials. In some embodiments, act 1208 may include acquiring the secure content container from an intermediate content store. Act 1210 scans the content and encrypts the content using the user credentials. The encrypted content is then placed into the secure content container at act 1212. Act 1214 sends the secure content container to the client computer. Act 1216 receives the secure content container at the client computer and decrypts the encrypted content using the user credentials.

### CONCLUSION

Various embodiments employ methods and techniques to manage content flow in an efficient and secure manner. The methods and techniques, in at least some embodiments, enable a content consumer to pull content from a content creator and further control access to content using various verification methods and protocols. Other embodiments allow for increased security in content push scenarios. Further to some embodiments, methods and techniques can be used to control access to and management of content via the acquisition and management of user credentials.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
providing a secure content container that contains an indication of at least one of user or client credentials; and
using the secure content container to implement a push or pull, print or scan scenario.

2. The method of claim 1, wherein the act of using comprises:
placing encrypted content into the secure content container, wherein the encrypted content is encrypted using the credentials.

3. The method of claim 2, wherein the act of using comprises:
receiving an indication of the credentials at a printer; and
based at least in part on the indication of credentials, retrieving, by the printer, the secure content container.

4. The method of claim 2, wherein the act of using comprises:
pushing, by a scanner, the secure content container out to one or more destinations, wherein the encrypted content in the secure content container comprises encrypted scanned content.

5. The method of claim 2, wherein the act of using comprises:
pushing, by a client, the secure content container to a printer.

6. The method of claim 5, further comprising:
requesting content at the printer; and
decrypting, at the printer, the encrypted content, wherein the encrypted content is decrypted using the credentials.

7. The method of claim 1, wherein the act of using comprises:
acquiring the secure content container at a scanner;
scanning content at the scanner; and
encrypting the content with the credentials;

8. The method of claim 7, further comprising:
receiving, at a client, the secure content container; and
decrypting the encrypted content using the credentials.

9. One or more computer-readable media embodying computer-readable instructions which, when executed by one or more processors, cause the one or more processors to implement a method comprising:
assembling a secure content container, wherein the secure content container comprises an indication of credentials and content that is encrypted using credentials; and
using the secure content container to implement a push or pull, print or scan scenario.

10. The one or more computer-readable media of claim 9, further comprising:
providing an indication of credentials to a printer; and
retrieving credentials at the printer, wherein the retrieving is based at least in part on the indication of credentials.

11. The one or more computer-readable media of claim 10, further comprising:
retrieving, at the printer, the secure content container, wherein the retrieving is based at least in part on the indication of credentials;
decrypting the encrypted content using the credentials; and
printing the decrypted content.

12. The one or more computer-readable media of claim 10, wherein the retrieving comprises:
querying a network for one or more secure content containers associated with the indication of credentials; and
retrieving, from the network, the secure content container.

13. The one or more computer-readable media of claim 9, further comprising sending the secure content container to a network.

14. The one or more computer-readable media of claim 9, wherein the secure content container further comprises content routing data.

15. The one or more computer-readable media of claim 9, wherein the secure content container further comprises content processing data.

16. A method comprising:
providing content to a scanner;
providing an indication of credentials to the scanner;
scanning the content; and
encrypting, by the scanner, the content using user credentials.

17. The method of claim 16 further comprising, prior to encrypting the content, retrieving credentials based at least in part on the indication of user credentials.

18. The method of claim 16, further comprising assembling, by the scanner, a secure content container that contains the encrypted content and the indication of credentials.

19. The method of claim 18, fixer comprising pushing, by the scanner, the secure content container to one or more destinations.

20. The method of claim 19, further comprising:
receiving, at one or more destinations, the secure content container; and
decrypting the encrypted content using the credentials.
